(19) United States
(12) Patent Application Publication
(10) Pub. No.: US 2018/0191393 A1
(43) Pub. Date: Jul. 5, 2018

(54) CASES FOR MOBILE PHONES CONTAINING COMPONENTS

(71) Applicant: TRUST TECHNOLOGY WORLD DMCC, Dubai (AE)

(72) Inventors: Joshua Mihill, Grantham Lincolnshire (GB); Wayne Butner, Vancouver (CA)

(21) Appl. No.: 15/737,638

(22) PCT Filed: Jun. 17, 2016
(86) PCT No.: PCT/IB2016/053616

§ 371 Date: Dec. 18, 2017

(30) Foreign Application Priority Data
Jun. 19, 2015 (GB) 1510788.1

(51) Int. Cl. H04B 1/3888; A45C 11/00; H04B 1/3827

(52) U.S. Cl. CPC H04B 1/3888; A45C 2011/002; H04B 1/3838; A45C 11/00

(57) ABSTRACT

Components and/or accessories of a mobile phone are included in the case of the phone and a case containing components and accessories.

### FIELD

The present invention relates to cases that are used to tightly contain portable devices such as mobile telephones and portable computers in particular it relates to the use of the case to contain accessories or components useful in the phone. It also relates to cases containing the component and/or accessory.

### BACKGROUND

Cases for mobile telephones are well known and are known to provide protection and to enable ready holding and use of the telephone. They need to fit around the telephone, they need to allow easy insertion and removal of the telephone into and from the case while also ensuring a secure fit. They need to provide impact protection for the telephone in case it is knocked or dropped. Additionally they need to allow connections such as chargers, headphones and the like to be connected to the telephone. They need to be lightweight and small in order to be readily held in use and carried easily such as in a pocket or handbag. Finally they need to have a low surface coefficient of friction so that the telephone within the case can be readily placed in and removed from a receptacle such as a users pocket or handbag. Cases that fold around the telephone are known as are cases into which the telephone is a sliding fit.

Examples of such cases may be found in European Patent Publication Number 2393731.

### SUMMARY

We have now found that components and/or accessories of the mobile phone can be included in the case rather than in the telephone handset itself.

The present invention therefore provides a case which satisfies these requirements and contains one or more components or accessories of the mobile communication device.

### BRIEF DESCRIPTION OF DRAWINGS

FIG. 1 shows a case for a mobile telephone in which a coil for the generation of a remedial signal in relation to potentially harmful radiation is embedded.

FIG. 2 is a schematic circuit diagram showing an alternate system with both an antenna and a microcontroller as part of the case of a mobile telephone.

### DETAILED DESCRIPTION

There are many components and/or accessories that may be included in the case. For example there are systems which provide a remedial signal for the reduction or elimination of potentially harmful radiation that may be emitted by the communication device. The remedial signal can be generated by a coil and the coil could, with advantage, be included in the case. This can enable wireless charging as well as providing strength and rigidity to the case. It would also allow for use of a larger coil than could be provided in association with the battery of the device or within the handset of the device which could allow the generation of a larger remedial field covering a larger area.

Another component that could be included in the case is the antenna that may be used for the detection of potentially harmful radiation emitted by the device. The antenna can be used to monitor the radiation level, monitor the general use, verify bills etc. Incorporating the antenna within the case rather than within the handset of the device would place the antenna further away from the device reducing the risk of interference between the two.

The operation of many features of a mobile communication device is often managed by a microcontroller and this too could be located within the case of the device.

The microcontroller can control any of the electrical features of the device such as wireless charging of the battery, monitoring battery power levels, turning any remedial signal on or off and also activating the recordal of operation of the device including the generation of potentially harmful radiation. Any data module that may be employed for capturing data and also for providing additional data storage for the device such as music, files, photographs, videos and the like could also be provided in the case.

The battery or additional battery power could be provided in the case in order to extend the life of the device. In this instance an indicator device such as an LED could be provided in the case to indicate that various aspects of the device such as charging, remedial signal generation, data recordal are operational or not.

Where the component that is in the case is a permanent component such as the antenna it may be embedded in the case particularly if the case is formed by injection moulding when the case material may be injected around the component.

The invention may be used with any cases used with mobile telephones. Folding cases, slide fit cases etc. In one embodiment the case comprises a trough component comprising a base and circumferentially extending side walls adapted to enclose a portable electronic device while leaving a surface of the device exposed. According to our copending Application 1505909 the trough may be formed with a transverse flexible hinge which divides the trough component into two sections, whereby the first section can be displaced to allow insertion of the telephone into the second section whereupon the first section can be placed around the portable electronic device to hold it securely within the case. This design of case, which allows the phone to be slid in and out of the case while remaining a single piece case, is especially useful when applied to cases that physically connect with the ports of the phone. An example of this type of case is a case that contains a battery and must connect to the power port to provide additional power to a phone.

In a preferred embodiment at least parts of the trough shaped element of the case may be overmoulded with an elastomeric material which provides protection for the case and the portable telephone within the case in the event of an impact. In particular the side walls and the perimeter of the first section may be overmoulded. The elastomeric material can provide a softer material for holding the telephone in use and also to provide a non-slip surface. The elastomeric material can also provide a flexible bond line between the two sections of the trough component that together constitute the trough component of the case thereby providing the hinge between the two sections of the trough component.

Both the walls of the trough component and any elastomeric covering can be provided with through holes that can align with the ports of the telephone when it is in position within the case so that the telephones ports such as a lightning connector, micro USB ports, audio jacks, chargers and the like can be accessed to provide a necessary communication to the telephone while it is within the case. It is preferred that the first section of the case which can be displaced about the hinge does not contain such through holes as the hinging activity may eventually lead to misalignment of the through holes and any ports in the telephone. In some instances however the positioning of the features of a phone may require that holes also be in the first section.

The inner trough component of the case is preferably of a hard, substantially rigid material. It is preferred that it be of a substantially rigid plastic such as a olefin polymer or copolymer such as polypropylene or ethylene/propylene copolymers, polyamides such as the various nylon grades, polyesters such as polyethylene terephthalate or polybutylene terephthalate, thermoplastic polyurethanes or styrene/butadiene copolymers. The plastic may be filled with a filler such as glass or carbon fibre to provide additional strength. Where the trough component comprises two sections it is preferred that the sections are produced from the same material. In a further preferred embodiment the trough component of the case is made by injection moulding. The side walls of the trough component must be provided with cut outs or they may end at positions on both sides of the trough component where the sections meet at both ends of the hinge line to enable the upper first section to be displaced about the hinge line relative to the lower second section.

An elastomeric material may be provided on the trough component by any suitable technique, overmoulding, heat bonding and adhesive bonding are preferred methods. Overmoulding being the preferred technique. The elastomeric material may be natural or synthetic material, synthetic elastomers such as styrene/butadiene rubbers optionally containing acrylonitrile being particularly useful. The elastomeric material should be provided around the perimeter of the top first section of the trough component so that when it is replaced after insertion of the portable telephone into the bottom second section it will stretch over and secure the telephone within the trough component of the case. Elastomeric material may also be provided on the back of the trough component to provide a softer feel and to hide the hinge mechanism if that is desired.

The top of the walls of the trough component are preferably provided with an inwardly projecting lip so that the telephone can slide between the base of the trough and the inwardly projecting lip at the top of the walls of the trough component so that the portable telephone is held firmly in place by the base, side walls and inwardly projecting lip of the trough component.

The present invention may be used to provide cases for any mobile communications device. In the embodiment where the case is a tight fitting trough with walls the length and depth of the trough component of the case is selected according to the size and shape of the device with which it is to be used. The elastomeric covering material, when used, is preferably from 0.5 to 2 mm thick, more preferably 0.75 to 1.75 mm thick. The elastomeric layer preferably is provided on the exterior of at least part of the longitudinal sides of the trough component and also on the exterior of the wall at the top of the trough component including the inwardly projecting lip when used. Although not essential the elastomeric material may be provided over positions on the case which allow access to button controls of the portable telephone. In this way the buttons may be operated by pressing on the elastomeric material at the appropriate location. Alternatively or additionally ports can be provided in the elastomeric material and/or walls of the trough component to allow access to the operating buttons of the portable telephone. Where an elastomeric material is employed on the side walls of the trough component gaps should be provided in the elastomeric material at the ends of the hinge line to allow operation of the hinge to displace the first section to allow the insertion of the portable telephone into the second section of the case.

The component and/or accessory is usually located in the base of the case where there is more space although indicators such as LED's may be included in the side of the case to enable them to be readily visible to the user of the device.

The invention is illustrated by reference to the accompanying Figures.

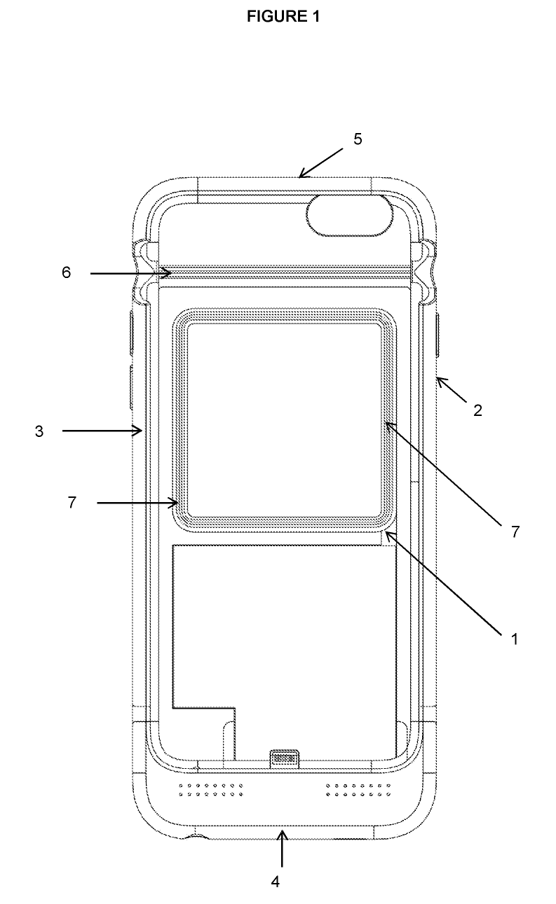

FIG. 1 is a plan view of a case into which a mobile telephone can be slotted. The case comprises a base section (1), side walls (2) and (3) and end walls (4) and (5). A hinge (6) is provided in the base section (1) to enable the case to be opened to allow insertion of the mobile telephone. (7) is a coil for generating a remedial signal in relation to potentially harmful radiation embedded in the base section (1) of the case.

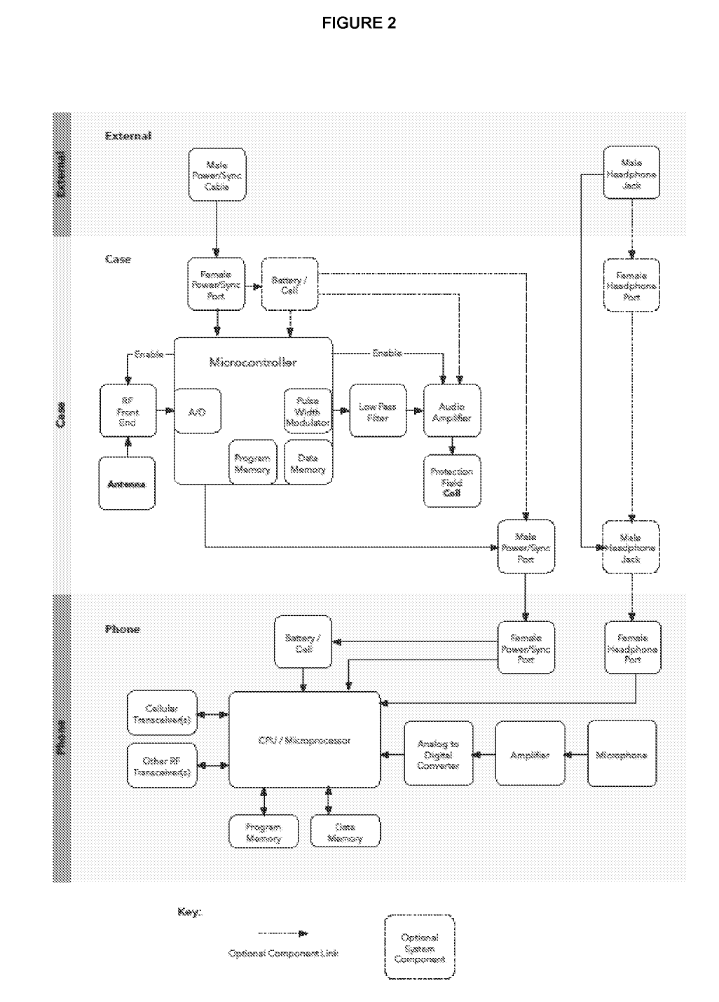

FIG. 2 shows schematically how components of the mobile phone can be located in the case and other components are located within the telephone itself and how the components may be linked within the case and within the telephone and also between the case and the telephone. Optional components and connections are shown in dotted lines.

1. A case for a mobile communication device which contains one or more components or accessories of the mobile communication device and in which the one or more components comprise a coil for generation of a remedial signal.

2. The case according to claim 1, wherein the one or more components comprise an antenna used for detection of potentially harmful radiation emitted by the mobile communication device.

3. The case according to claim 1, wherein the one or more components is a microcontroller that manages operation of the case.

4. The case according claim 1, wherein the one or more components comprise a data module for capturing data.

5. The case according to claim 1, wherein the one or more components comprise a battery or an additional battery.

6. The case according to claim 5, wherein the case contains as an additional component an indicator device.

7. The case according to claim 6, wherein the indicator device is an LED.

8. The case according to claim 1, wherein the mobile communication device is a portable telephone.

9. The case according to claim 1, wherein the mobile communication device is a portable telephone, and the portable telephone is located within the case.

10. The case according to claim 1, wherein the case is formed as a trough with a base and circumferentially extending side walls which are adapted to enclose the mobile communication device while leaving a surface of the mobile communication device exposed.

11. The case according to claim 10, wherein the base includes the coil embedded therein.

12. The case according to claim 11, wherein the case includes a flexible hinge in the base so the case is able to opened to allow insertion of the mobile communication device.

13. The case according to claim 12, wherein the coil is located between the flexible hinge and one of the side walls.

14. The case according to claim 10, wherein one or more indicators are located in one of the side walls.

15. The case according to claim 14, wherein the one or more indicators are an LED.

16. A case for a mobile communication device, wherein the case comprises one or more components or accessories of the mobile communication device, including:
a) an antenna which detects potentially harmful radiation emitted by the mobile communication device;
b) a coil which generates a remedial signal to reduce or eliminate the potentially harmful radiation;
c) a microcontroller which manages operation of the case; and
wherein the case adapted to receive the mobile communication device therein.

17. The case according to claim 16, wherein the case includes a battery.

18. The case according to claim 16, wherein the case is formed as a trough with a base and circumferentially extending side walls which are adapted to enclose the mobile communication device while leaving a surface of the mobile communication device exposed.

19. The case according to claim 18, wherein the base of the case includes the coil embedded therein.

20. The case according to claim 18, wherein the case includes one or more indicators located in one of the side walls.
